(19) United States
(12) Patent Application Publication
(10) Pub. No.: US 2009/0279941 A1
(43) Pub. Date: Nov. 12, 2009

(54) ADJUSTABLE JOINT FOR CUSTOMIZABLE FURNITURE

(76) Inventors: Michael Goldin, Berkeley, CA (US); Steven Goldin, Berkeley, CA (US)

Correspondence Address: BEESON SKINNER BEVERLY LLP, ONE KAISER PLAZA, SUITE 750, OAKLAND, CA, 94612, US

(21) Appl. No.: 12/437,480

(22) Filed: May 7, 2009

Related U.S. Application Data
(60) Provisional application No. 61/051,091, filed on May 7, 2008.

(51) Int. Cl. F16D 1/04

(52) U.S. Cl. 403/3

(57) ABSTRACT

An adjustable furniture joint for customizing furniture comprises a vertically disposed support having a longitudinally extending channel and opposing jaws defining an opening to the channel, the jaws having forward surfaces, one or more rear surfaces of a horizontal bracket in abutting engagement with the forward surfaces, a key cam having a neck, a head extending from said neck, and a longitudinal dimension, the head having a cross-sectional profile having two laterally extending ears, each ear having an inner surface inclined at an acute angle relative to the longitudinal dimension, the head slidingly received in the channel, the jaws having out-turned surfaces generally in parallel alignment and in abutting engagement with the inner surfaces of the ears, and means for biasing the head towards the bracket, application of the biasing force causing the inner surfaces of the ears to impinge on the out-turned surfaces of the jaws and urging the jaws inwardly towards the neck.

### CROSS-REFERENCE TO RELATED APPLICATIONS

This application claims the benefit of U.S. Provisional Application No. 61/051,091 filed May 7, 2008.

### FIELD OF THE INVENTION

This invention is directed to customizable furniture and in particular to an improved adjustable joint used in the construction of such furniture for providing a high degree of strength and versatility in the furniture product.

### BRIEF DESCRIPTION OF THE DRAWINGS

FIG. 1 is an exploded perspective view of a cam cylinder, clevis cam, and key cam of an adjustable joint according to the invention.

FIG. 2 is an exploded perspective view of a bracket assembly formed by assembling the bracket, clevis cam, pin, and key cam elements shown in FIG. 1.

FIG. 3 is an exploded perspective view of the bracket assembly being inserted into a frame column according to the invention.

FIGS. 4A-4D are end, side, bottom, and perspective views, respectively, of the key cam of the adjustable joint shown in FIG. 3.

FIGS. 5A-5C are perspective, end, and side views, respectively, of the pin shown in FIGS. 1 and 2.

FIGS. 6A-6C are end, bottom, and perspective views, respectively, of the frame column of the joint shown in FIG. 3.

FIGS. 7A-7D are perspective, top, end, and side views, respectively, of the clevis cam element shown in FIGS. 1 and 2.

FIGS. 8A-8D are side, top, front perspective, and rear perspective, respectively, views of the cam cylinder bracket shown in FIGS. 1-3.

FIG. 9 is a horizontal sectional view of the adjustable joint shown in FIGS. 1-8D taken through the middle of the device.

FIG. 10 is a vertical sectional view of the device taken along lines 10-10 of FIG. 9.

FIGS. 11A-11C are sectional views of the device taken along lines 11A-11A, 11B-11B, and 11C-11C of FIG. 9, showing points of apposition in the device that restrict rotation of the bracket about the x-axis.

FIG. 12 is a sectional view of the device similar to FIG. 10, showing the points of apposition in the device restricting movement of the bracket about the y-axis.

FIG. 13 is a simplified sectional view of the device similar to FIG. 9, showing the points of apposition in the device restricting movement of the bracket about the z-axis.

### DESCRIPTION OF THE ILLUSTRATED EMBODIMENT

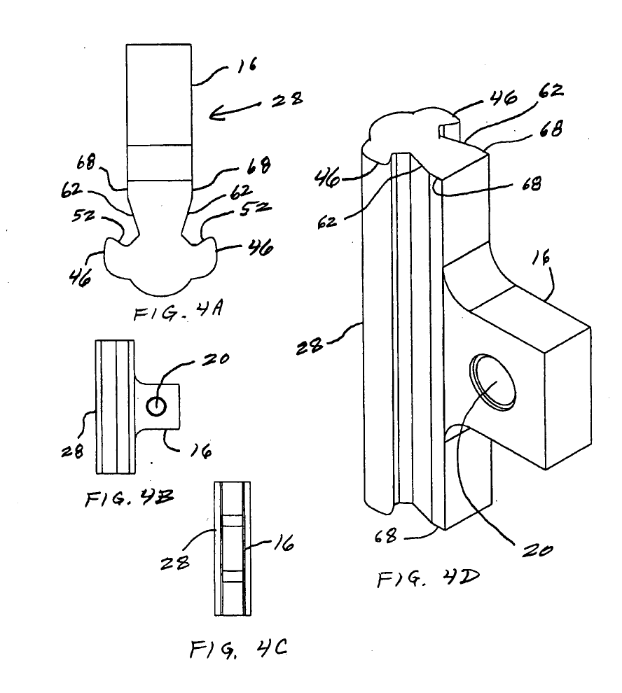

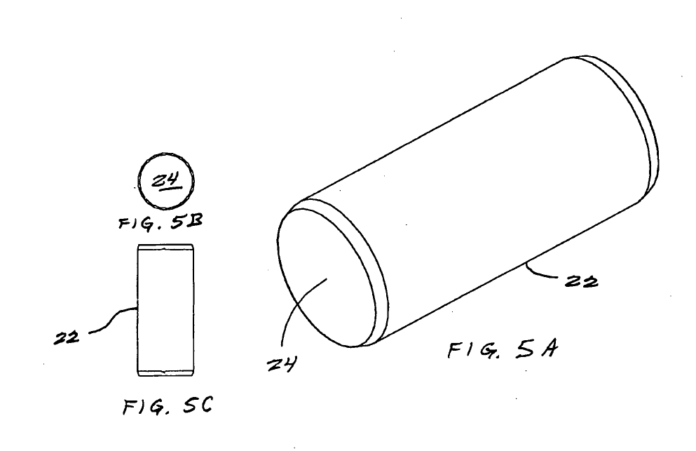

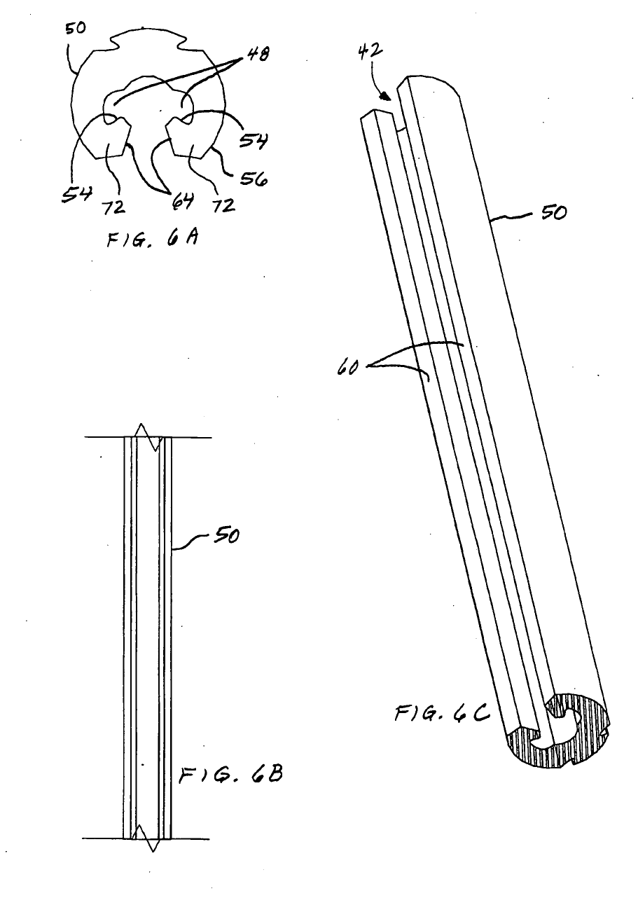

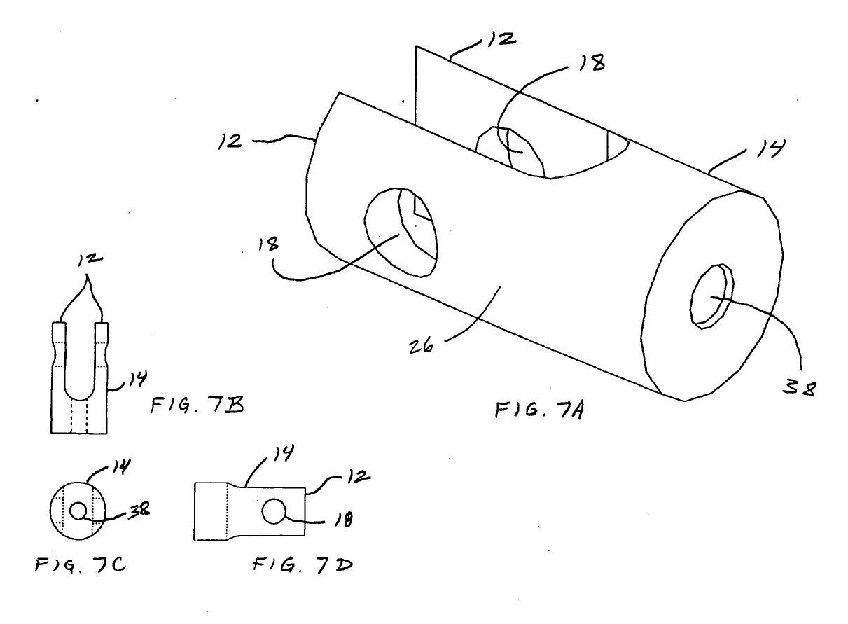

A fully assembled joint according to the invention is indicated at 10 in FIG. 3.

With initial reference to FIG. 1, the arms 12 of a clevis 14 are slid over a key cam tab 16 of key cam 28 so that the apertures 18 in the clevis arms 12 and the hole 20 in the key cam tab 16 align. Pin 22 is then passed through this set of holes such that its end faces are generally flush with the outer surfaces 26 of each clevis arm 12, thereby joining the clevis 14 and the key cam 28.

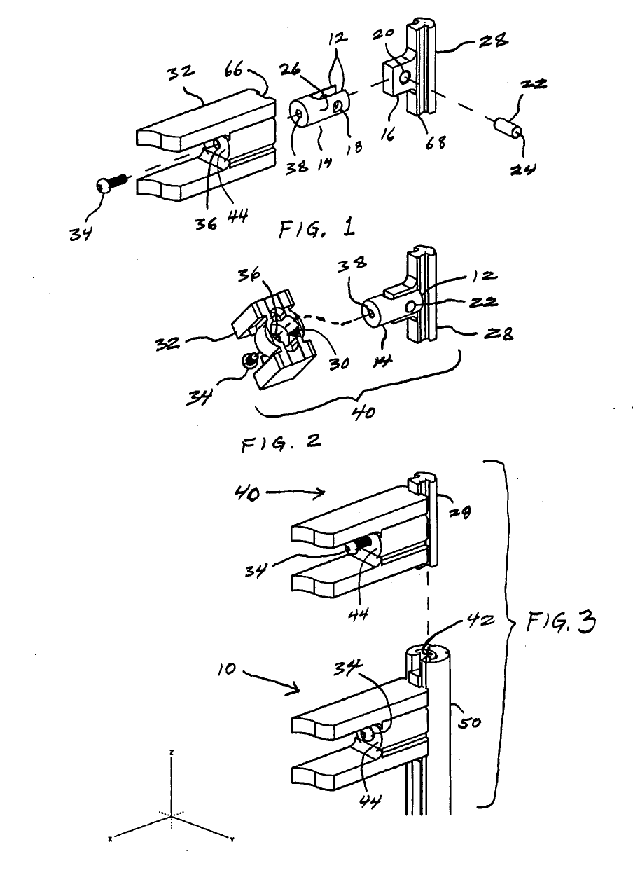

As shown in FIG. 2, the clevis 14 is then inserted into the rearwardly-opening pocket 30 of bracket 32, and secured with a button-head screw 34 passed through hole 36 in the forward wall 44 of pocket 30 and into threaded hole 38 of clevis 14 to form bracket assembly 40.

Referring to FIG. 3, key cam 28 is slid into channel 42 in support column 50, and once the bracket assembly 40 is positioned in a desired location along support 50, button-head screw 34 is further tightened.

As the screw 34 is tightened, clevis 14 is drawn toward forward wall 44, which in turn draws key cam 28 forward via pin 22 (see FIGS. 1 and 2). Pin 22 remains disposed in the clevis arms 12 because it is captured tightly in the clevis cam pocket 30. As key cam 28 advances, bracket arm proximal faces 58 and support faces 60 are brought into abutting engagement, and inner surfaces 52 of ears 46 of key cam 28 bear against out-turned surfaces 54 of jaws 72 of support 50 urging jaws 72 inwardly toward neck 62 of key cam 28, thereby securing bracket assembly 40 to support 50.

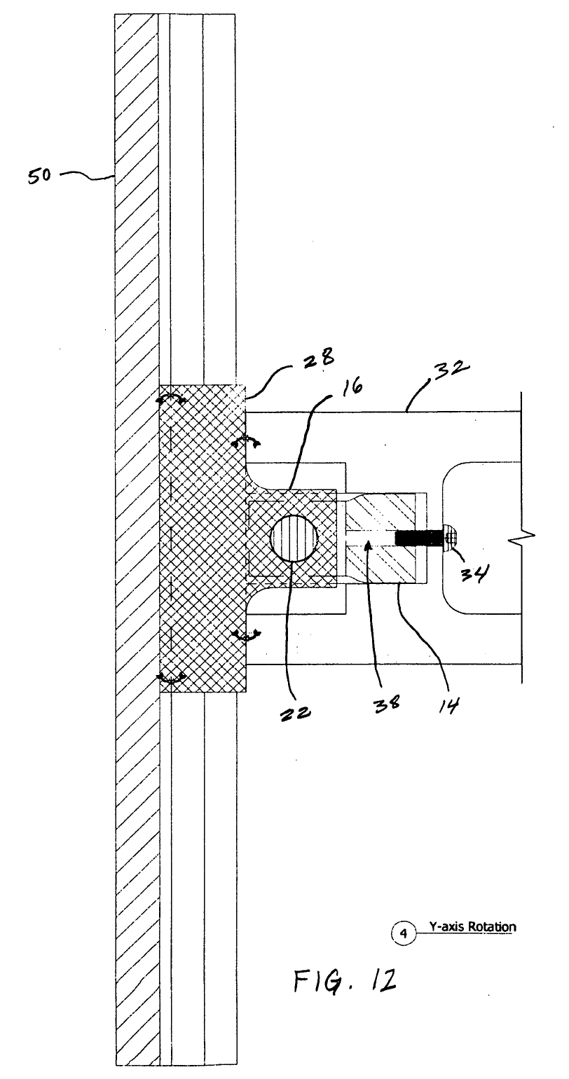

Essentially, the forces of the tightening button head screw 34 are transferred through the clevis 14, the pin 22, and the key cam 28, so that the inner surfaces 52 of the key cam ears 46 pull against out-turned surfaces 54 of support 50, biasing jaws 72 inward and resisting the splaying forces acting on support 50. See FIG. 9. Thus, bracket assembly 40 can be placed at an infinite number of positions along support 50 according to need as may best be understood by reference to FIG. 10.

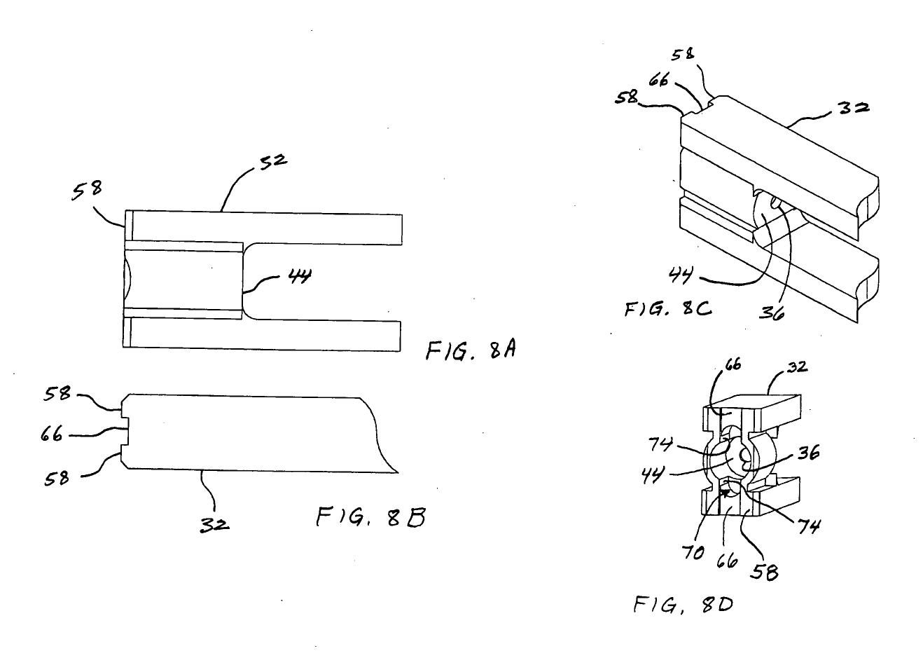

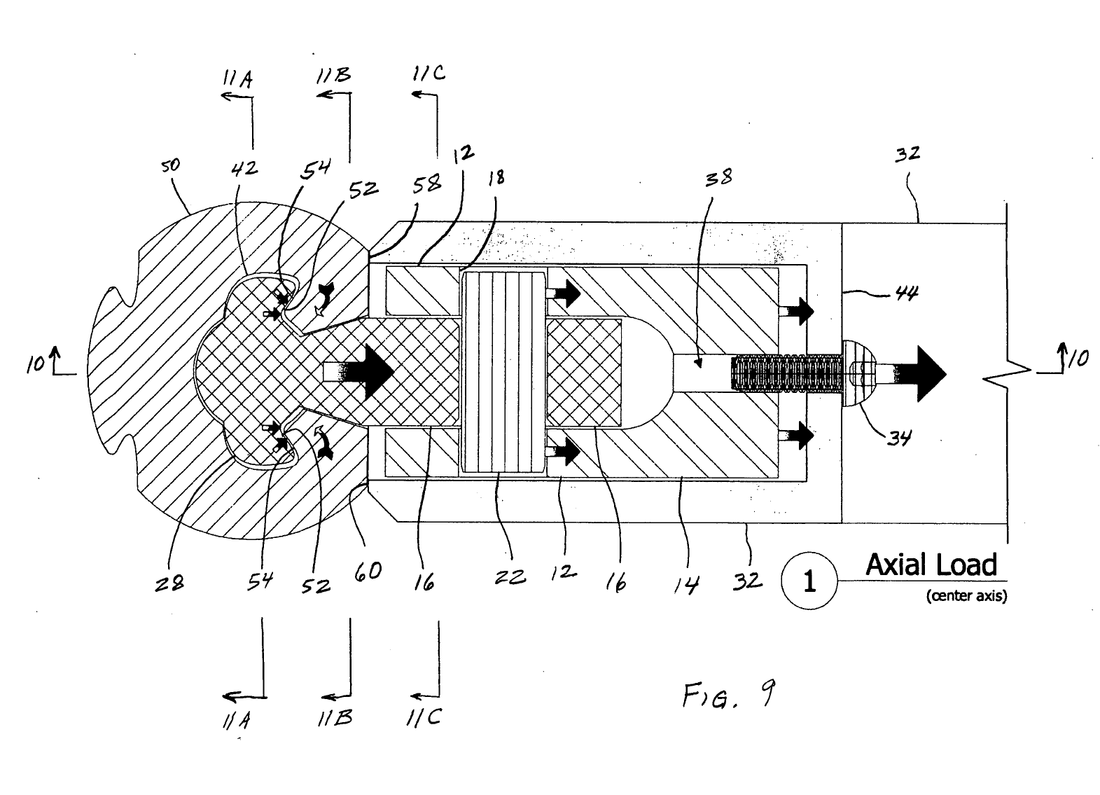

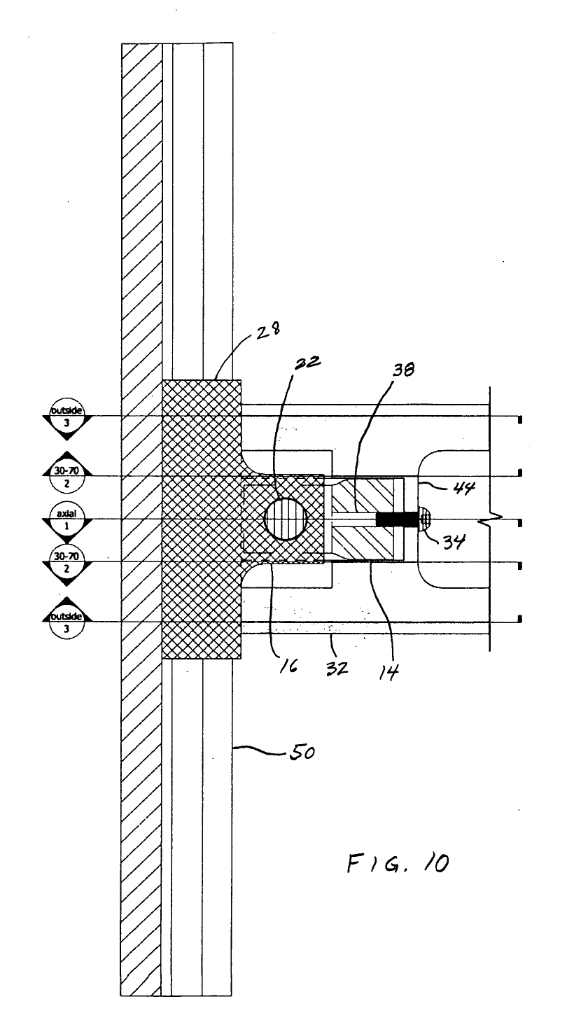

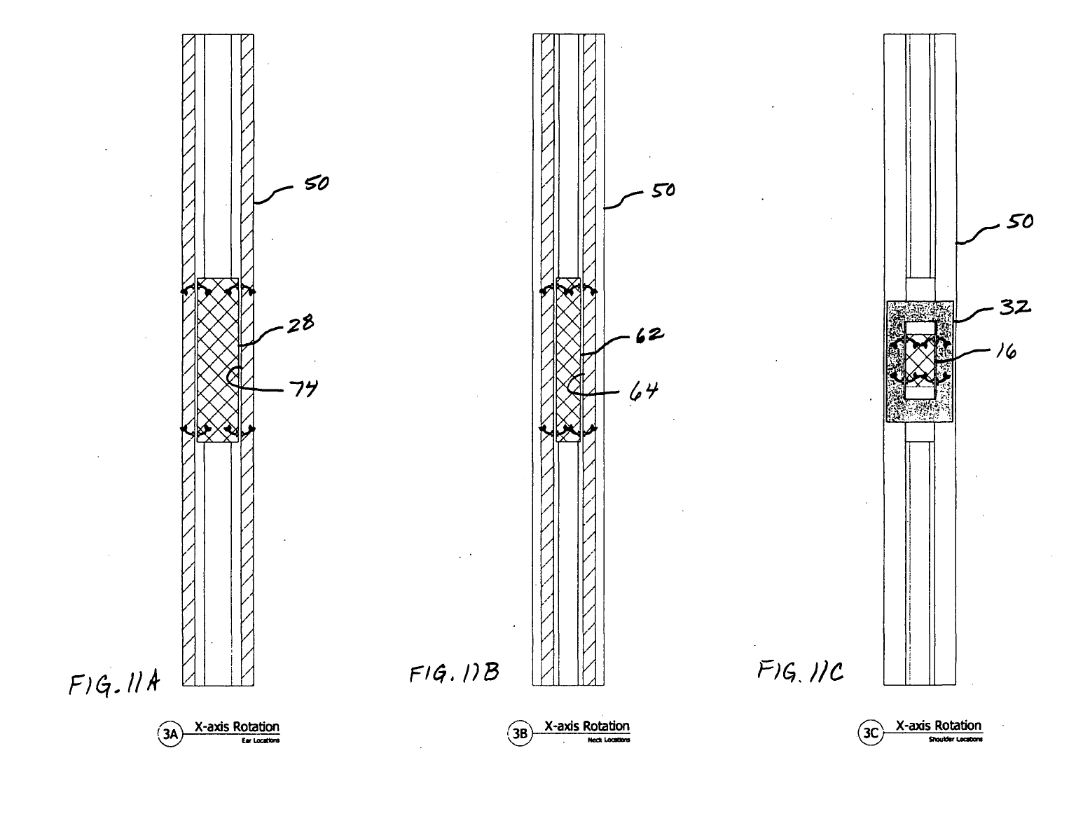

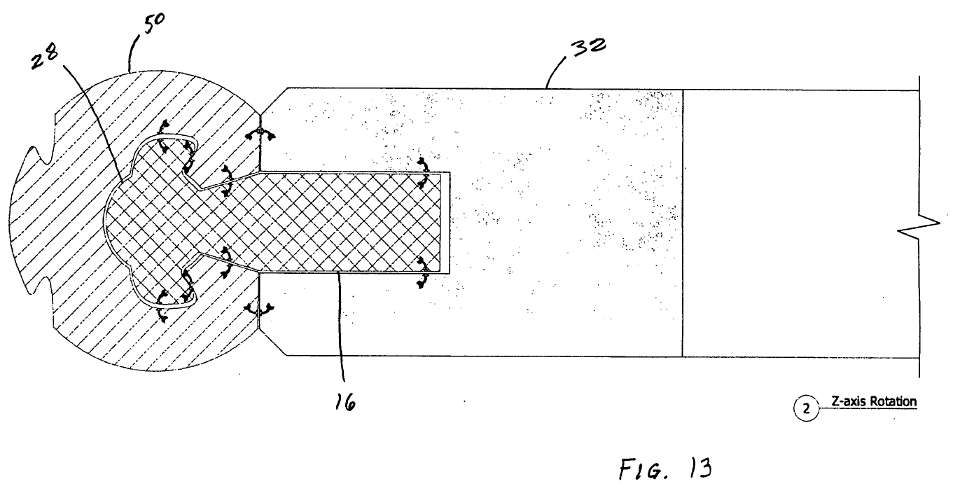

Rotation around the z-axis is prevented by the counter-posing forces of the (a) ears 46 (FIGS. 4A and 4B) and ear pockets 48 (FIG. 6A), (b) bracket arm proximal face 58 (FIGS. 8A-8D) and support face 60 (FIG. 6C), and (c) key cam neck 62 (FIG. 4A) and column jaw faces 64 (FIG. 6A). See also FIG. 13.

Rotation around the y-axis is prevented by the length of contact between bracket arm proximal face 58 (see FIG. 8D) and support face 60 (see FIG. 6C). See also FIG. 12.

Rotation around the x-axis is prevented by the counter-posing forces of (a) key cam tab 16 (see, e.g., FIG. 1) and sidewalls 74 of key cam tab anti-rotation slot 70 (see FIG. 8D), and (b) key cam shoulder 68 (see, e.g., FIGS. 4A and 4D) and walls 76 of the key cam shoulder anti-rotation slot 66 (see FIG. 8D), and (c) apposition of inner surfaces 52 of key cam ears 46 and out-turned surfaces 54 of support 50 (see FIG. 9). See also FIGS. 11A-11C.

There have thus been described certain preferred embodiments of an adjustable furniture joint. While preferred embodiments have been described and disclosed, it will be recognized by those with skill in the art that modifications are within the true spirit and scope of the invention. The appended claims are intended to cover all such modifications.

We claim:

1. An adjustable furniture joint comprising:
a vertically disposed support having a longitudinally extending channel and opposing jaws defining an opening to said channel, said jaws having forward surfaces,
a horizontal bracket having one or more rear surfaces in abutting engagement with said forward surfaces,
a key cam having a neck, a head extending from said neck, and a longitudinal dimension, said head having a cross-sectional profile having two laterally extending ears, each ear having an inner surface inclined at an acute angle relative to said longitudinal dimension, said head slidingly received in said channel, said jaws having out-turned surfaces generally in parallel alignment and in abutting engagement with said inner surfaces of said ears, and
means for biasing said head towards said bracket, application of said biasing force causing said inner surfaces of said ears to impinge on said out-turned surfaces of said jaws and urging said jaws inwardly towards said neck.

2. The adjustable furniture joint of claim 1 further comprising:
a clevis having two spaced apart arms, each arm having an aperture,
said means for biasing including said bracket having a rearwardly opening pocket, said key cam having a tab extending from said neck opposite said head, said tab having an opening, said tab interposed between said arms,
a pin received in said opening of said tab and said apertures of said arms, said key cam in pivoting engagement with said clevis about said pin, and
said clevis, tab and pin received in said pocket.

3. The adjustable furniture joint of claim 2 further comprising:
said pocket having a forward wall having a hole,
a threaded fastener received in said hole, and
said clevis having a threaded aperture, said threaded fastener threadedly received in said threaded aperture, tightening of said fastener urging said clevis, pin, and key cam towards said bracket.
